(19) United States
(12) Patent Application Publication
(10) Pub. No.: US 2004/0195211 A1
(43) Pub. Date: Oct. 7, 2004

(54) Double-axis double-speed linear motor mechanism

(76) Inventor: Yung-Tsai Chuo, Taichung (TW)

Correspondence Address: CHARLES E. BAXLEY, ESQ., 90 JOHN STREET, THIRD FLOOR, NEW YORK, NY, 10038, US

(21) Appl. No.: 10/828,015

(22) Filed: Apr. 20, 2004

Related U.S. Application Data
(63) Continuation-in-part of application No. 10/216,641, filed on Aug. 12, 2002, now abandoned.

(51) Int. Cl. B23H 7/30

(52) U.S. Cl. 219/69.2

(57) ABSTRACT

The present invention provides an electrical discharge machine (EDM) with double-axis double-speed linear motor mechanism for fast machining operation. In this EDM the tool fixture assembly is driven by a linear motor, whiles the work piece platform assembly is driven by another linear motor in the opposite direction. Applying no contact direct drive, such as linear motors, eliminates wear problem in ballscrews in conventional embodiments and enhances availability of the machine. Opposite and double motors drive configuration not only increases relative speed between the tool electrode and the work piece, but also stabilize the speedy jump operation by canceling reaction force of tool electrode movement.

### FIELD OF THE INVENTION

The present invention relates to a double-axis double-speed linear motor mechanism, applicable especially to machines demanding fast feed rate between the work pieces and the tools, such as high speed sculpturing machines, PCB drill machines, rapid prototyping machines, electric discharge machine (EDM) and other electronics production equipments.

### BACKGROUND OF THE INVENTION

In order to increase the work efficiency of machine, each movement time of the machine needs to be reduced, that is to say that the movement speed and acceleration of the moving mechanism need to be increased. The relative speed and acceleration between the tools and the work pieces especially need to be increased because they are the key points of efficiency improvement.

Nevertheless, there is a limitation to increase the movement speed of the mechanism. Using a high-speed servomotor with a belt pulley transmission mechanism to increase revolutions per minute, using a high-lead screw shaft, or using high-speed linear motor to drive the mechanism is one of the ways to increase the speed and acceleration. There are shortcomings for those conventional ways which will be explained as follows:

In order to operate at high speed, not only the speed but the acceleration have to be increased; otherwise, the speed of the mechanism begins to slow down before the maximum speed is reached. Even if the maximum speed is reached, the travel distance for the mechanism running at the maximum speed is pretty short, in this case, the maximum speed can only be kept for a short period of time, as a result, not much time can be saved and the mechanism contributes little to improving the work efficiency.

Accordingly, not only the maximum speed has to be increased, the high acceleration is also important. In those ways to increase the speed, the linear motor can make the fastest maximum speed and acceleration. The maximum acceleration for high-speed linear motor is about 4G (G represents the gravity acceleration). The platform usually has a huge mass so that it is difficult to accelerate the heavy platform to 4G and normally it only can be accelerated to 1 G. Some prior arts use one motor to drive two moving objects to move in opposite direction, however, the more objects one motor drives, the greater the resistance will be, but the slower the acceleration rate of the moving objects will be. Because the acceleration is not high enough, the platform starts to reduce its speed before a maximum speed is reached. Accordingly, the distance that the platform travels at the maximum speed is very limited. The conventional high-speed moving mechanism needs to be improved.

The present invention intends to provide a double-axis double-speed linear motor mechanism. It has inherited the advantage of linear motors, that is, high speed and acceleration characteristics. And it has increased the relative speed and acceleration between the work piece and the tool by the simultaneous motion in both axes. When both axes move at the same speed but in the opposite direction, the relative speed is doubled compared to the conventional design. This allows the machining speed and acceleration of the present invention to be increased and meets the requirement of saving machining time.

### SUMMARY OF THE INVENTION

An object of the present invention is to provide an electric discharge machine that has a more reliable drive mechanism for machining.

Another object of the present invention is to provide an electrical discharge machine that is able to perform high speed and yet stable and precise “jump” procedure than existing embodiment.

The present invention proposes a double-axis double-speed linear motor mechanism that has a base on which a work piece platform assembly and a tool fixture assembly resides. The work piece platform moves along the first axis on the base. The tool fixture assembly moves along the second axis parallel to the first axis. The tools used to process the work piece are installed in the tool fixture. In order to increase both relative speed and acceleration between the tools and the work pieces so as to save the machining time, when the work piece platform in accordance with the present invention moves along the first axis, the tool moves in a parallel but opposite direction along the second axis, such that the speed between the work piece platform and the tool fixture is the sum of the speed of the work piece platform relative to the base and the speed of the tool fixture relative to the base. When both speeds equal to the conventional mechanism's speed, the speed between the work piece platform and the tool fixture is twice as much as that of the conventional mechanism, the acceleration between the work piece platform and the tool fixture is also twice as much as that of the conventional mechanism. This is the benefit of increasing one more linear motor set for reducing the moving time. In order to prevent the problem of acceleration slowing down caused by one motor driving two objects, each axis in accordance with the present invention can be driven by an independent motor. Linear motors are employed to drive the work piece platform and the tool so as to increase the desired speed of the double-axis double-speed linear motor mechanism. In a typical linear motor application, the speed between the work piece platform and the base can exceed 120 meters per minute, and the acceleration can exceed 1G. In the present invention, the speed and acceleration of the tool relative to the base can be the same as that in the conventional case, and the speed and acceleration of the work piece relative to the base can be the same, too. Since the work piece platform and the tool in accordance with the present invention are designed to move in opposite direction, the relative speed between them can reach 240 meters per minute, and the relative acceleration can reach 2G.

The speed and the acceleration can reach the desired value so that the speed and the acceleration of the double-axis double-speed linear motor mechanism are double compared to the conventional ones.

For the present invention, one might think that one more motor is needed for driving the additional axis so that the cost will be increased. However, the motor cost is just a portion of the total cost of the mechanism. The slightly increase for the motor is worthy. The axis driven in only one direction is changed into two axes driven in opposite directions; the stroke of the moving axis is reduced to half. This space-saving reduces the cost so that the final cost varies slightly and the efficiency is increased dramatically, which is worthy.

The present invention will become more obvious from the following description when taken in connection with the accompanying drawings which show, for purpose of illustration only, a preferred embodiment in accordance with the present invention.

### BRIEF DESCRIPTION OF THE DRAWINGS

FIG. 1 shows a double-axis double-speed linear motor mechanism in accordance with the present invention, and

FIG. 2 shows a right side view of the double-axis double-speed linear motor mechanism in accordance with the present invention;

FIG. 3 shows a cross sectional view of a double-axis double-speed linear motor mechanism in accordance with a second embodiment of an electric discharge machine of the present invention;

FIG. 4 shows a side view of a double-axis double-speed linear motor mechanism in accordance with a second embodiment of an electric discharge machine of the present invention;

FIG. 5 shows a stereographic view of a double-axis double-speed linear motor mechanism in accordance with a second embodiment of an electric discharge machine of the present invention;

FIG. 6 shows a cross sectional view of a double-axis double-speed linear motor mechanism in accordance with a third embodiment of an electric discharge machine of the present invention;

FIG. 7 shows a longitudinal cross-sectional view of the linear motor mechanism for driving the tool electrode in accordance with present invention;

FIG. 8 shows a lateral cross-sectional view of the linear motor mechanism for driving the tool electrode in accordance with present invention.

### DETAILED DESCRIPTION OF THE PREFERRED EMBODIMENTS

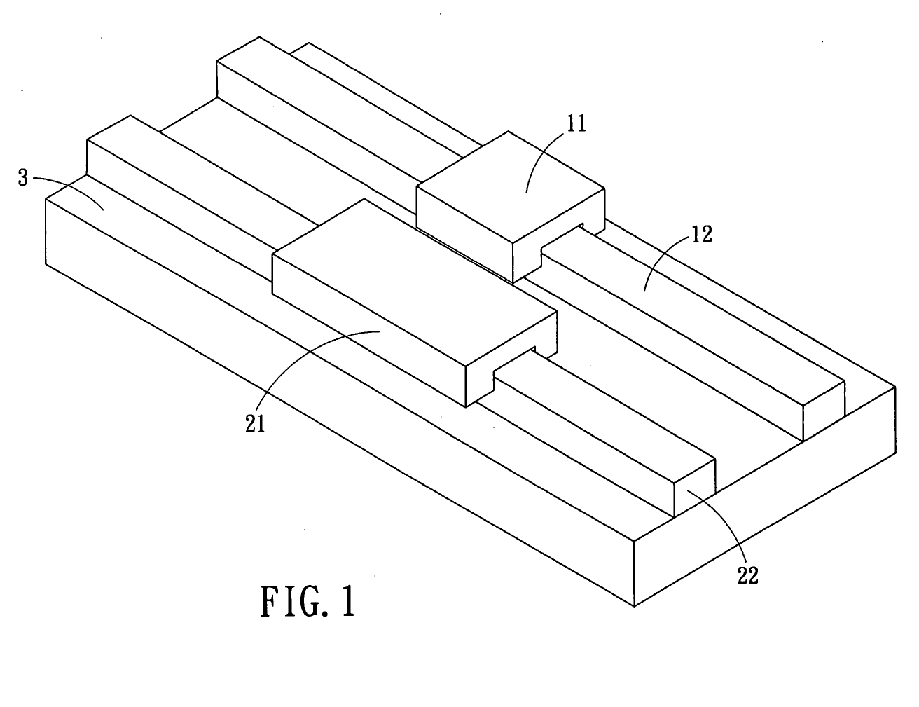

Referring to FIG. 1 which shows a double-axis double-speed linear motor mechanism of the present invention and comprises a base 3 to which a work piece platform 21 for carrying work pieces and a work piece drive axis 22 for driving the work piece platform 21 are connected, wherein the work piece platform 21 and the work piece drive axis 22 are called as a work piece platform assembly. A tool fixture 11 for fixing a tool and a tool drive axis 12 for driving the tool fixture 11 are also connected to the base 3. The tool fixture 11 and the tool drive axis 12 are called as a tool fixture assembly. The tool drive axis 12 is connected to the base 3 and parallel to one surface of the base 3. The work piece platform 21 is connected to the work piece drive axis 22 and movable along the work piece drive axis 22. For convenience of description, the work piece drive axis 22 is named as a first axis. The tool fixture 11 is connected to the tool drive axis 12 and movable along the tool drive axis 12. The tool drive axis 12 and the work piece drive axis 22 move parallel to each other. When the work piece platform 21 moves along the first axis, the tool fixture 11 in the second axis is driven to move in the opposite direction to the work piece platform. The relative speed between the work piece platform 21 and the tool fixture 11 is therefore the sum of the speed of the work piece platform 21 relative to the base 3 and the speed of the tool fixture 11 relative to the base 3. Similarly, the relative acceleration between the work piece platform 21 and the tool fixture 11 is the sum of the acceleration of the work piece platform 21 relative to the base 3 and the acceleration of the tool fixture 11 relative to the base 3. The relative speed between the work piece platform 21 and the tool fixture 11 is twice as much as that of the conventional mechanism, and the relative acceleration between the work piece platform 21 and the tool fixture 11 is twice as much as that of the conventional mechanism.

In order to achieve the desired speed and acceleration, the mechanism of the present invention employs linear motors to drive the work piece platform 21 and the tool fixture 11. The driving mechanisms for driving the work piece platform 21 and the tool fixture 11 are independent from each other, and the weight of the object to be driven in accordance with the present invention is also no heavier than that of the conventional mechanism, thereby the relative speed and relative acceleration between the work piece platform 21 and the tool fixture 11 in accordance with the present invention can be doubled as compared to the conventional mechanism.

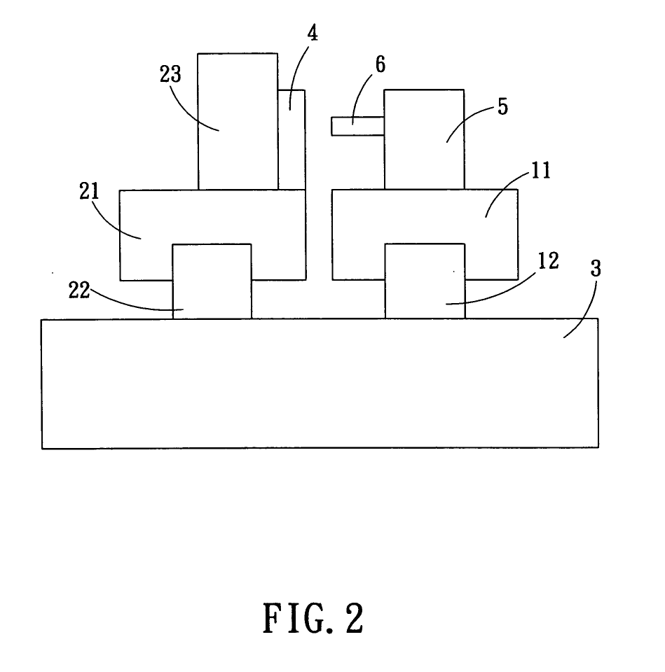

FIG. 2 shows a right side view of the double-axis double-speed linear motor mechanism of the present invention and what is disclosed in an embodiment of the present invention. In this embodiment, the work piece fixing base 23 is assembled to the work piece platform 21 and the work piece 4 is fixed to the work piece fixing base 23. The tool fixture 11 has a tool axis 5 which drives the tool 6 to access to or move away from the work piece in left and right direction as shown in FIG. 2. This is an application embodiment of the mechanism as shown in FIG. 1 and which is used for those which have slower moving speed but require rapid positioning, such as the PCB drill. The tool 6 and the work piece 4 in this embodiment can move at a high relative speed while each axis is moving at the speed of the conventional mechanism. Since an effect of double axis and double speed can be achieved in the direction of the work piece drive axis 22 in accordance with the embodiment of the present invention, such that the work efficiency of the mechanism of the present invention is substantially increased.

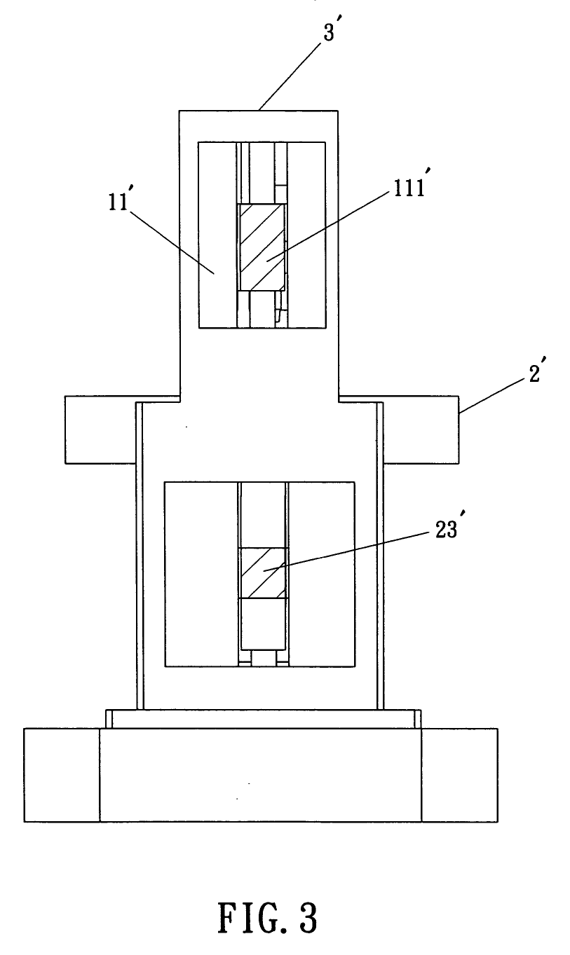

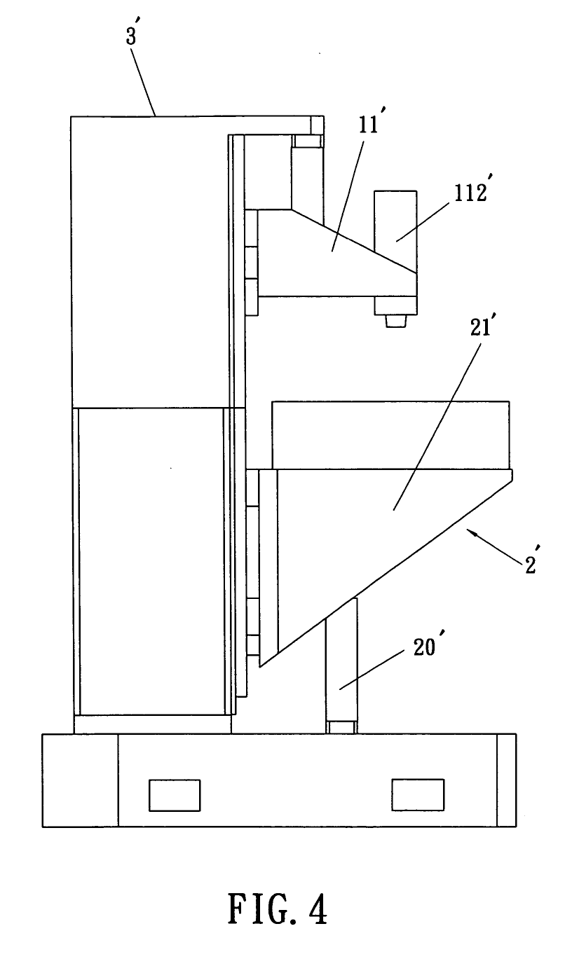

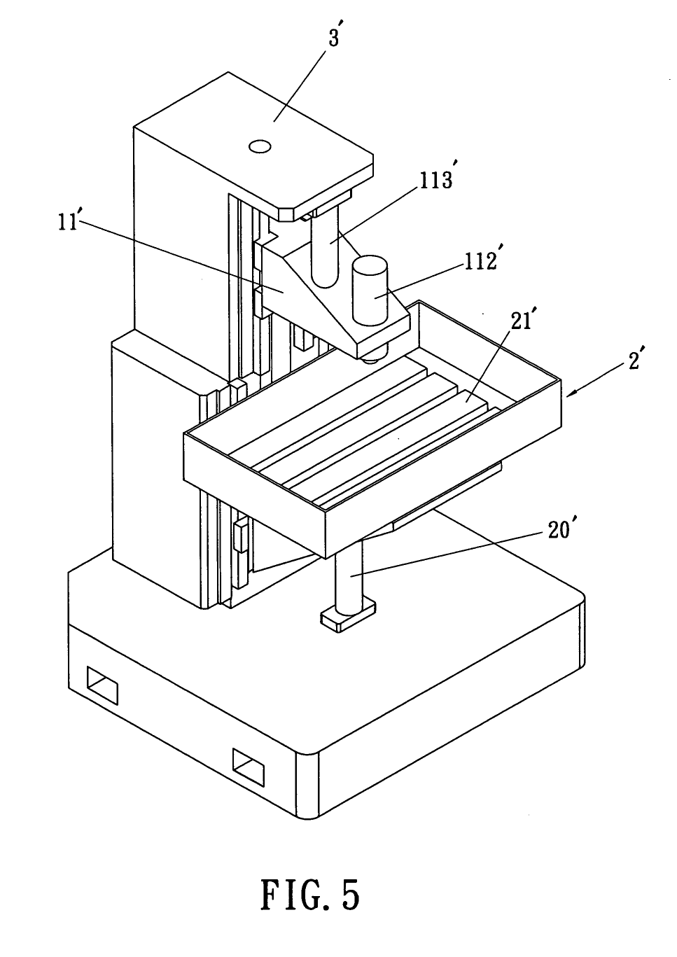

To better under the present invention, please refer to FIGS. 3-8, which show another embodiment of Z-axis an electric discharge machine (EDM) of the present invention. The EDM comprise a base 3′, a tool fixture assembly 11′ mounted on the base 3′, and work piece platform assembly 2′ on which the work piece is fixed. The tool fixture assembly 11′ comprises a linear motor assembly 111′, which drives the tool electrode 112′ whose moving axis parallel to the surface of the base 3′, and an air cylinder 113′, which compensates weight of the motor linear assembly 111′ and the tool electrode 112′. The work piece platform assembly 2′ comprises a work piece platform 21′ carrying the workpiece, an air cylinder 20′ compensating weight of the work piece platform 21′, and linear motor assembly 23′, which is mounted on the same motion axis of the linear motor assembly 111′ and moves the work piece platform 21′.

In comparison with conventional ballscrews whose driving force is generated by physical contact between nut and spindle, linear motors are non-contact and maintenance-free. It performs higher speed positioning since there is no ball circulation wear problem inherited in ballscrews.

During machining, when the linear motor assembly 111′ drives the tool electrode 112′ in one direction, another linear motor assembly 23′ moves the work piece platform 21′ in the opposite direction. Through this way, the relative speed between the tool electrode 112′ and the work piece platform 21′ is increased, and a high effective jump operation can be realized. In addition, the reaction force created by the highly repetitive movement of work piece platform assembly 2′ is canceled, and a stable and precise “jump” procedure can be ensured.

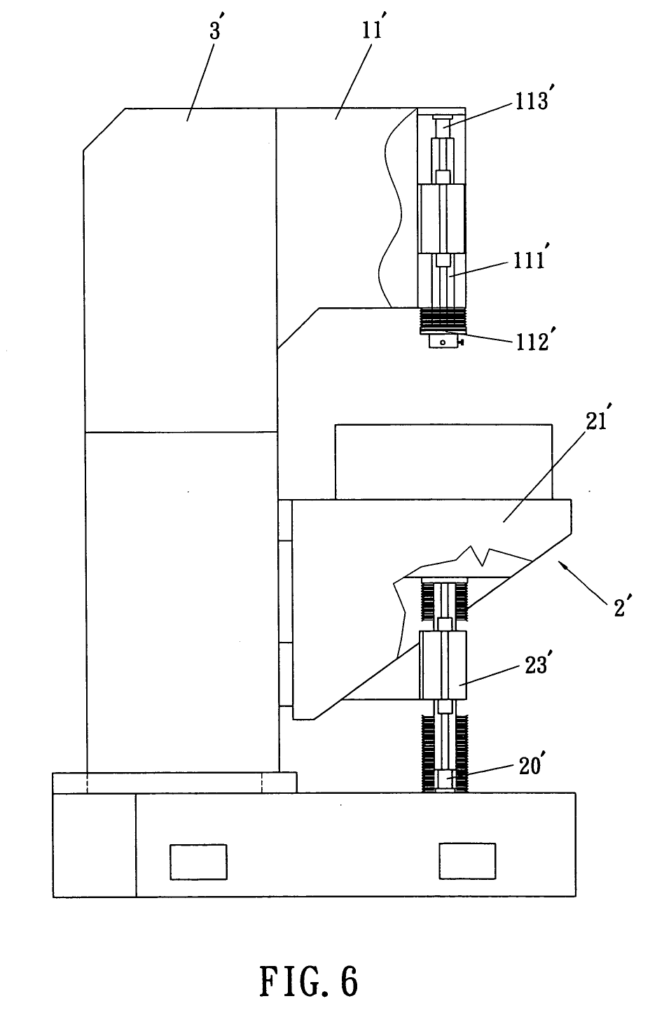

FIG. 6 shows another embodiment of an electric discharge machine of the present invention where hollow cylindrical linear motors are used. Inside the linear motor assembly 111′ the air cylinder 113′ for counter-balance is mounted. On one end of the linear motor assembly 111′ the tool electrode 112′ is attached. On the same motion axis, another linear motor assembly 23′ with air cylinder 20′ drives the work piece platform 21′ in opposite moving direction of the tool electrode 112′.

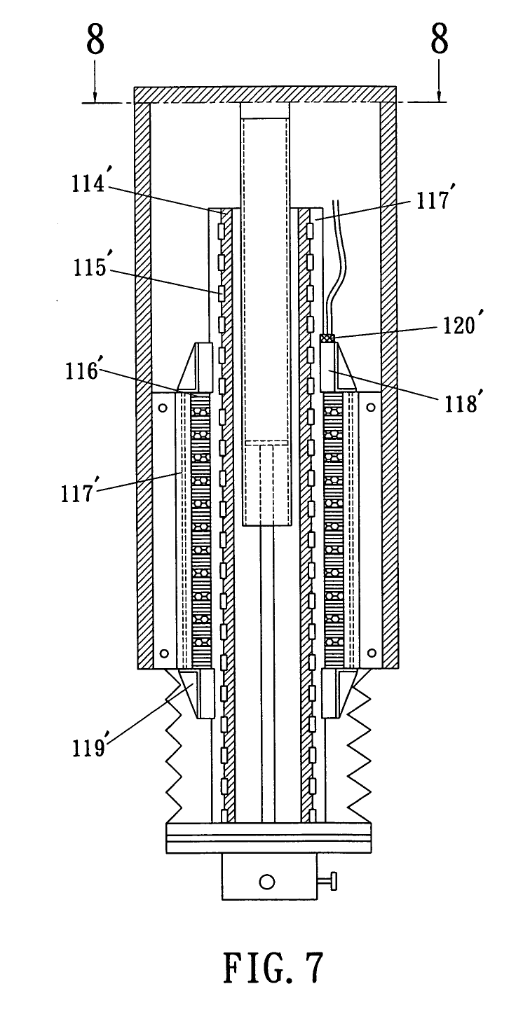

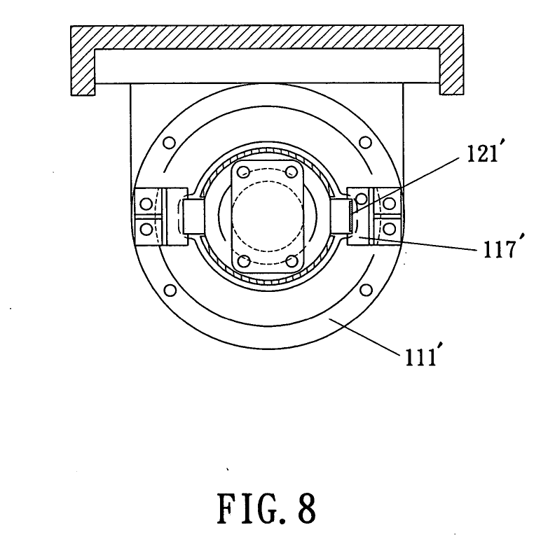

FIGS. 7 and 8 illustrates details of the hollow cylindrical linear motor assembly 111′ shown in FIG. 2. The linear motor assembly 111′ comprises a hollow cylindrical forcer 114′, circular permanent magnets 115′ mounted on the outer cylindrical surface of the forcer 111′, a hollow cylindrical stator 116′ with motor windings surrounded by cooling module 117′, 2 linear guide ways 117′ on which slide blocks 118′ connected with the stator 116′ through the bracket 119′, a linear encoder read head 120′ which is mounted inside the slide block 118′ and detects tool electrode's position from a linear scale 121′ glued on guide way surface.

In the second embodiment driving forces generated by hollow cylindrical linear motor pass through the center of mass of the tool fixture assembly as well as the work piece platform assembly. This saves equipment space, eliminates disturbance torque moments created by non-co-centric driving, and ensures higher speed and yet very stable machining.

In sum, the present invention has the following advantages as compared to the conventional mechanism:

1. Maintenance-free and more reliable operations.

2. Higher speed jump operation, and thus higher productivity and

3. More stable positioning of the tool electrode, and thus superior surface machining quality

4. Space saving through using direct drive motors, without intermediate power transmission elements, such as nuts and couplings.

While we have shown and described the embodiment in accordance with the present invention, it should be clear to those skilled in the art that further embodiments may be made without departing from the scope of the present invention.

What is claimed is:

1. A double-axis double-speed linear motor mechanism, applicable especially to electric discharge machining apparatus, comprising:
a base;
a work piece platform assembly connected to said base and including a work piece platform for work pieces to be fixed thereon, said work piece platform assembly is movable along a first axis which is parallel to a surface of said base, and said work piece platform driven by a linear motor; and
a tool fixture assembly connected to said base and a tool electrode fixed on said tool fixture assembly, said tool electrode movable along a second axis parallel to said first axis, and said tool electrode driven by a linear motor, when said work piece platform moves in one direction of said first axis, said tool moves in an opposite direction to that of said work piece platform along said second axis said so that said work piece platform and said tool move at a high speed with respect to each other.

2. The double-axis double-speed linear motor mechanism as claimed in claim 1, wherein said linear motor for driving said work piece platform and said linear motor for driving said tool fixture assembly are independent from each other.
